(19) United States
(12) Patent Application Publication
(10) Pub. No.: US 2011/0211051 A1
(43) Pub. Date: Sep. 1, 2011

(54) DISPLAY DEVICE AND METHOD OF DRIVING THE SAME

(75) Inventors: Jae-sung PARK, Seoul (KR); Tae-hyeun HA, Suwon-si (KR); Jung-jin PARK, Seongnam-si (KR); Nak-won CHOI, Incheon (KR)

(73) Assignee: SAMSUNG ELECTRONICS CO., LTD., Suwon-si (KR)

(21) Appl. No.: 12/861,281

(22) Filed: Aug. 23, 2010

(30) Foreign Application Priority Data
Feb. 26, 2010 (KR) 10-2010-0018039

(51) Int. Cl. H04N 13/04

(52) U.S. Cl. 348/53; 348/E13.075

(57) ABSTRACT

A display device is provided. The display device includes a signal receiving unit which receives an image signal including a left image and a right image; a signal processing unit which processes the image signal received by the signal receiving unit; a display unit which displays a three-dimensional image based on the image signal processed by the signal processing unit; a user input unit which receives user input regarding an operation mode of the three-dimensional glasses; a synchronizing signal output unit which outputs a synchronizing signal to open and close the left shutter and the right shutter of the three-dimensional glasses corresponding to the left image and the right image, respectively; and a controller which controls the synchronizing signal output unit to output the synchronizing signal based on the operation mode of the three-dimensional glasses obtained from the received user input.

### CROSS-REFERENCE TO RELATED APPLICATION

This application claims priority from Korean Patent Application No. 10-2010-0018039, filed on Feb. 26, 2010 in the Korean Intellectual Property Office, the disclosure of which is incorporated herein by reference in its entirety.

### BACKGROUND

1. Field

Apparatuses and methods consistent with the exemplary embodiments relate to a display device and a method of driving the same, and more particularly, to a display device which is capable of outputting a synchronizing signal corresponding to 3D glasses and a method of driving the same.

2. Description of the Related Art

A three-dimensional (3D) image displayed by a display device such as a TV has a stereoscopic effect by using a binocular parallax which is a major factor to allow three-dimensional recognition at a short distance.

The 3D image may be viewed with 3D shutter glasses. When the display device transmits a synchronizing signal to the 3D glasses, the 3D glasses open and close the left shutter and right shutter, respectively, using the synchronizing signal at the time when left and right images are displayed.

Meanwhile, the 3D glasses may operate with a synchronizing signal with a specific frequency or specific wavelength. Thus, if a mode of transmitting a synchronizing signal is changed, e.g., the display device changes a frequency of a synchronizing signal, a user may not use the 3D glasses since the display device is not compatible with the 3D glasses.

### SUMMARY

Accordingly, an aspect of one or more exemplary embodiments is to provide a display device which outputs a synchronizing signal corresponding to an operation mode of 3D glasses so that a user may use the 3D glasses even if a transmitting mode of a synchronizing signal is changed and a method of driving the same.

The foregoing and/or other aspects may be achieved by providing a display device including: a user input unit which receives user input regarding an operation mode of three-dimensional glasses for viewing an image displayed on the display device; a synchronizing signal output unit which outputs a synchronizing signal to open and close a left shutter and a right shutter of the three-dimensional glasses corresponding to a left image and a right image displayed on the display device, respectively; and a controller which controls the synchronizing signal output unit to output the synchronizing signal based on the operation mode of the three-dimensional glasses provided in the received user input.

The controller may control the display device to display information about at least one operation mode of the three-dimensional glasses for selection by a user of the operation mode of the three-dimensional glasses.

The information about the operation mode of the three-dimensional glasses may include a model name of the three-dimensional glasses.

The controller may change a frequency of the synchronizing signal based on the operation mode of the three-dimensional glasses.

The controller may change a wavelength of the synchronizing signal based on the operation mode of the three-dimensional glasses.

The synchronizing signal output unit may include a plurality of emitters which output a plurality of different synchronizing signals, respectively.

The synchronizing signal output unit may include an emitter which selectively outputs a plurality of different synchronizing signals.

The synchronizing signals may be different in at least one of frequency and wavelength.

According to another aspect of an inventive concept, there is provided a method of driving a display device, the method including receiving user input regarding an operation mode of a three-dimensional glasses for viewing an image displayed on the display device; and outputting a synchronizing signal based on the operation mode of the three-dimensional glasses provided in the received user input to open and close a left shutter and a right shutter of the three-dimensional glasses corresponding to a left image and a right image displayed on the display device, respectively.

The method may further include displaying information about at least one operation mode so a selection of the operation mode of the three-dimensional glasses is made by a user.

The outputting the synchronizing signal may include changing a frequency of the synchronizing signal based on the operation mode of the three-dimensional glasses.

The outputting the synchronized signal may comprise changing a wavelength of the synchronizing signal based on the operation mode of the three-dimensional glasses.

The outputting the synchronized signal may include outputting the synchronizing signal from a plurality of emitters which output a plurality of different synchronizing signals, respectively.

The outputting the synchronized signal may include outputting the synchronizing signal from an emitter which selectively outputs a plurality of different synchronizing signals.

The synchronizing signals may be different in at least one of frequency and wavelength.

According to yet another aspect of the inventive concept, there is provided a display device including: a synchronizing signal output unit which outputs a plurality of synchronizing signals to open and close a left shutter and a right shutter of a three-dimensional glasses for viewing an image displayed on the display device corresponding to a left image and a right image displayed on the display device, respectively; and a controller which controls the synchronizing signal output unit to output a synchronizing signal based on an operation mode of the three-dimensional glasses, where the plurality of synchronizing signals are different in at least one of frequency and wavelength.

According to another aspect of the inventive concept, there is provided a method of driving a display device. The method includes: outputting a synchronizing signal based on an operation mode of a three-dimensional glasses for viewing an image displayed on the display device, among a plurality of synchronizing signals being different in at least one of frequency and wavelength, in order to open and close a left shutter and a right shutter of the three-dimensional glasses corresponding to a left image and a right image displayed on the display device, respectively.

### BRIEF DESCRIPTION OF THE DRAWINGS

The above and/or other aspects will become apparent and more readily appreciated from the following description of the exemplary embodiments, taken in conjunction with the accompanying drawings, in which:

FIG. 1 is a block diagram illustrating a configuration of a display device according to an exemplary embodiment.

FIG. 2 is a view illustrating information about an operation mode of the 3D glasses displayed in the display device according to an exemplary embodiment.

FIG. 3 is a time chart illustrating a change of a frequency of a synchronizing signal output from the display device according to an exemplary embodiment.

FIG. 4 is a diagram illustrating a change of a wavelength of a synchronizing signal output from the display device according to an exemplary embodiment.

FIG. 5 is a flow chart illustrating an operation of the display device according to an exemplary embodiment.

### DETAILED DESCRIPTION OF EXEMPLARY EMBODIMENTS

Below, exemplary embodiments will be described in detail with reference to accompanying drawings so as to be easily realized by a person having ordinary skill in the art. The inventive concept may be embodied in various forms without being limited to the exemplary embodiments set forth herein. Descriptions of well-known parts are omitted for clarity, and like reference numerals refer to like elements throughout.

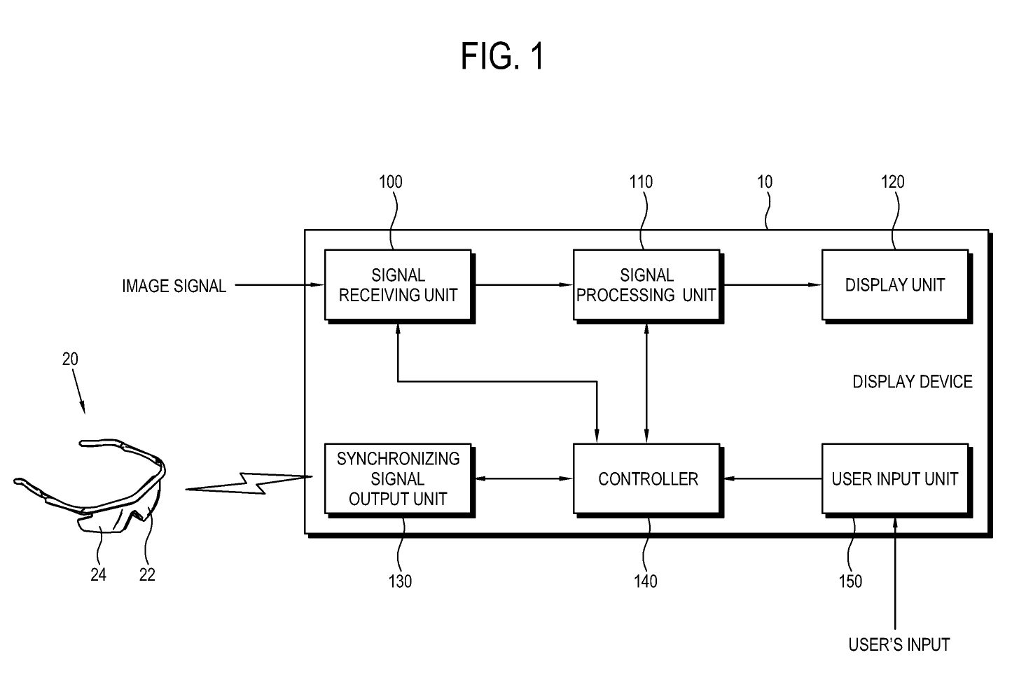

FIG. 1 is a block diagram illustrating a configuration of a display device according to an exemplary embodiment.

Referring to FIG. 1, the display device 10 according to an exemplary embodiment includes a signal receiving unit 100, a signal processing unit 110, a display unit 120, a synchronizing signal output unit 130, a controller 140, and a user input unit 150.

The signal receiving unit 100 receives an image signal including left and right images. The image signal received by the signal receiving unit 100 further includes broadcasting signals such as DTV signals, cable broadcasting signals, etc. In this case, the signal receiving unit 100 may receive a broadcasting signal of a channel selected by a user via tuning according to control by the controller 140. Moreover, the image signal received by the signal receiving unit 100 includes signals output from a video device such as a DVD, BD, etc. In addition, although not shown, the signal receiving unit 100 may receive an audio signal for audio output, a data signal for output of data information, etc. In an exemplary embodiment, an image signal, an audio signal, and a data signal may be received together through a single broadcasting signal.

The signal processing unit 110 processes a signal so that image signals including left and right images may be displayed into 3D images on the display unit 120. Signal processing conducted by the signal processing unit 110 includes decoding, image enhancing, scaling, etc. Furthermore, the signal processing unit 110 may perform demultiplexing which is sorting broadcasting signals received through the signal receiving unit 100 into image, audio, and data signals, decoding audio and data signals, etc. In this case, the display device 10 may further include an audio output unit (not shown) which outputs a sound based on an audio signal processed by the signal processing unit 110, e.g., a speaker.

The display unit 120 displays an image on the basis of an image signal processed by the signal processing unit 110. The display unit 120 may use, for example, an LCD type to display an image. In this case, although not shown, the display unit 120 may include an LCD panel, a panel driver, a backlight, etc. The backlight may include a light source, e.g., an LED. The display unit 120 may display data information included in a data signal processed by the signal processing unit 110.

The synchronizing signal output unit 130 outputs a synchronizing signal to open and close a left shutter 22 and a right shutter 24 of 3D glasses 20 corresponding to a left image and a right image, respectively. The synchronizing signal output unit 130 outputs a synchronizing signal according to control by the controller 140 and may include an emitter which outputs a synchronizing signal as an infrared signal. The emitter may include a light emitting diode, LED, which generates light with a specific wavelength.

Meanwhile, the synchronizing signal output unit 130 may include a plurality of emitters. Each emitter outputs a specific synchronizing signal, and synchronizing signals emitted from the emitters have different frequencies or wavelengths. Further, the synchronizing signal output unit 130 may include a single emitter which selectively outputs a plurality of synchronizing signals with different frequencies or wavelengths.

The user input unit 150 receives user's input related to an operation mode of the 3D glasses 20. The 3D glasses 20 may have a different operation mode. Thus, when a user selects an operation mode of the 3D glasses 20, the display device 10 outputs a synchronizing signal corresponding to the selected 3D glasses 20. The 3D glasses 20 having a different operation mode means a frequency or a wavelength of a signal to operate the 3D glasses 20 is different depending on the 3D glasses 20.

The controller 140 controls other components of the display device 10, such as the signal processing unit 110. Further, when a user selects the operation mode of the 3D glasses 20, the controller 140 controls the synchronizing signal output unit 130 to output a synchronizing signal corresponding to the operation mode of the 3D glasses 20. Moreover, the controller 140 may display information about the operation mode of the 3D glasses 20 so that the user may easily select the operation mode of the 3D glasses 20. The information about the operation mode of the 3D glasses 20 may include a model name of the 3D glasses 20, a frequency and a wavelength of an operating signal, etc. If a plurality of 3D glasses 20 are provided, the controller 140 displays information about an operation mode of each 3D glasses 20.

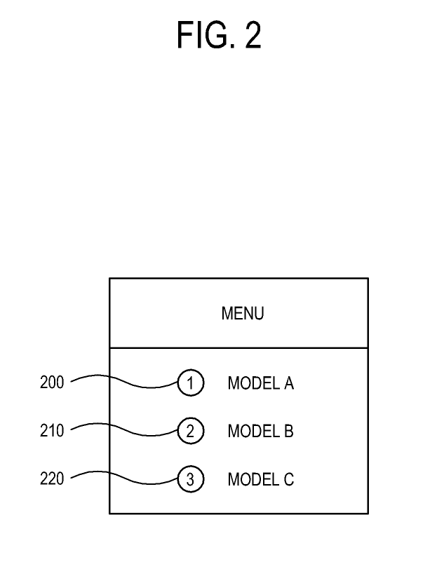

FIG. 2 is a view illustrating information about an operation mode of the 3D glasses 20 displayed in the display device 10 according to an exemplary embodiment.

For user's convenience, FIG. 2 shows displaying a model name of the 3D glasses 20 used by a user. When the user selects specific 3D glasses 20 from model names of the 3D glasses 20, i.e., MODEL A 200, MODEL B 210, and MODEL C 220, the controller 140 outputs a synchronizing signal corresponding to the selected 3D glasses 20. In addition to the model names of the 3D glasses 20, the controller 140 may display a frequency or wavelength of an operating signal of the 3D glasses 20. Also, if no model name is displayed, the controller 140 may display a frequency or wavelength of an operating signal of the 3D glasses 20 itself so that the frequency or wavelength is selectable, or it may allow a user to directly input a frequency or wavelength of an operating signal.

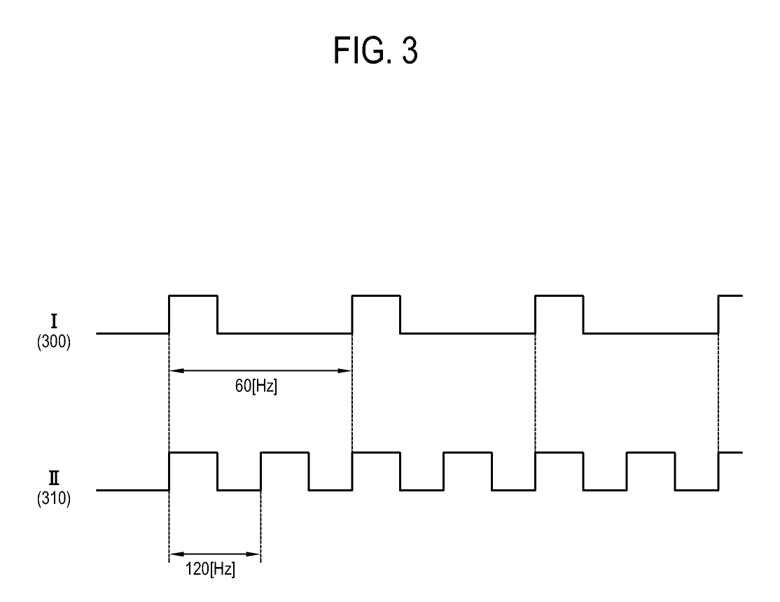

FIG. 3 is a timing chart illustrating a change of a frequency of a synchronizing signal output from the display device 10 according to an exemplary embodiment.

Observing an operation process of the display device 10 and the 3D glasses 20, the display device 10 displays left and right images quickly and in an alternating manner and opens and closes the shutter 3D glasses 20 to synchronize with the left and right images, thereby realizing a 3D image. That is, when the left images of the display device 10 are displayed on a screen, the left shutter 22 of the 3D glasses 20 is opened and the right shutter 24 is closed. When the right images of the display device 10 are displayed, the right shutter 24 of the 3D glasses 20 is opened and the left shutter 22 is closed.

In FIG. 3, I 300 shows that the display device 10 and the 3D glasses 20 operate at 60 [Hz], and II 310 shows that the display device 10 and the 3D glasses 20 operate at 120 [Hz]. When a left or a right image is displayed by the display device 10, a synchronizing signal is generated to be in a high state/. In this high state, the left shutter 22 or the right shutter 24 of the 3D glasses 20 is opened/closed.

In a case the display device 10 operates at a driving frequency of 60 [Hz] and changes to 120 [Hz], if the synchronizing signal output unit 130 output a synchronizing signal via changing a frequency i.e., 120 [Hz], the 3D glasses 20 operating at 120 [Hz] can provide a clear image to a user, while for the 3D glasses 20 operating at 60 [Hz] it is difficult to provide a clear image. Thus, the controller 140 controls the synchronizing signal output unit 130 to output a synchronizing signal corresponding to a driving frequency of the 3D glasses 20. To this end, the synchronizing signal output unit 130 may include a plurality of emitters outputting a 60 [Hz] synchronizing signal and a 120 [Hz] synchronizing signal, respectively, and thus if the user selects an operation mode of 3D glasses 20, the controller 140 controls the synchronizing signal output unit 130 to output a synchronizing signal corresponding to the selected 3D glasses 20. Alternatively, a single emitter may output a synchronizing signal corresponding to the selected 3D glasses 20 through a frequency conversion or the like.

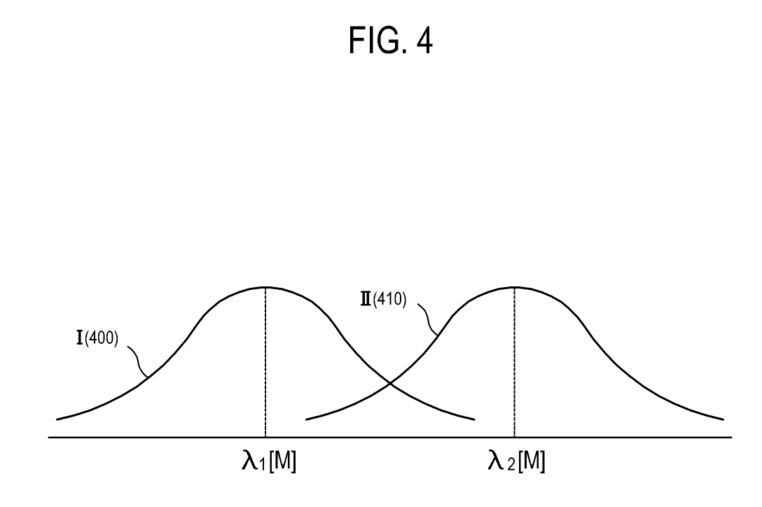

FIG. 4 is a chart illustrating a change of a wavelength of a synchronizing signal output from the display device 10 according to an exemplary embodiment.

I 400 shows a synchronizing signal that has a centroid wavelength of λ1 [M], and II 410 is shows a synchronizing signal that has a centroid wavelength of λ2 [M]. LEDs included in the synchronizing signal output unit 130 emit light with a centroid wavelength in a specific range. Thus, the synchronizing signal output unit 130 may change a wavelength of a synchronizing signal output.

Meanwhile, the 3D glasses 20 can be operated when a centroid wavelength of a synchronizing signal is in a specific range, which is different on 3D glasses 20. Therefore, when a centroid wavelength of light output from the synchronizing signal output unit 130 is changed and in this case the 3D glasses 20 which the user uses is not operated at the centroid wavelength of the output light, a clear image may be difficult to provide. To prevent this phenomenon, the controller 140 controls the synchronizing signal output unit 130 to output a synchronizing signal corresponding to an operation wavelength at which the 3D glasses 20 operates. For this, the synchronizing signal output unit 130 may include a plurality of emitters outputting a Xl [M] synchronizing signal and a λ2 [M] synchronizing signal, respectively, and thus if the user selects an operation mode of 3D glasses 20, the controller 140 controls the synchronizing signal output unit 130 to output a synchronizing signal corresponding to the selected 3D glasses 20. Alternatively, a single emitter may output a synchronizing signal corresponding to the selected 3D glasses 20 through a wavelength conversion or the like.

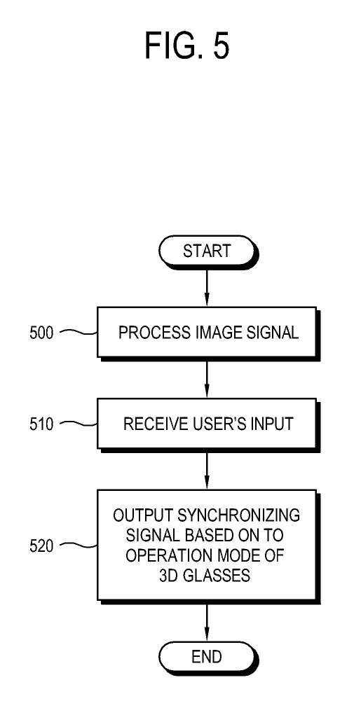

FIG. 5 is a flow chart illustrating an operation of the display device 10 according to an exemplary embodiment.

When an image signal including left and right images is received by the signal receiving unit 100, the signal processing unit 110 processes the received image signal to be displayed (500). Further, the controller 140 displays information about operation modes of 3D glasses 20 and receives information about an operation mode of 3D glasses 20 selected by a user (510). Then, the controller 140 outputs a synchronizing signal corresponding to the operation mode of the 3D glasses 20 according to the input by the user in order to open/close the left shutter 22 and the right shutter 24 of the 3D glasses 20 corresponding to the left and right images (520).

As described above, in the exemplary embodiment, even if a display device changes a mode of transmitting a synchronizing signal, a display device is capable of outputting a synchronizing signal corresponding to an operation mode of 3D glasses, and thus a user can use the old 3D glasses.

Further, a user can view the 3D images displayed in an old display device even when 3D glasses are replaced.

Although a few exemplary embodiments have been shown and described, it will be appreciated by those skilled in the art that changes may be made in these exemplary embodiments without departing from the principles and spirit of the invention, the scope of which is defined in the appended claims and their equivalents.

What is claimed is:

1. A display device comprising:
a synchronizing signal output unit which outputs a synchronizing signal to open and close a left shutter and a right shutter of a three-dimensional glasses corresponding to a left image and a right image displayed on the display device, respectively; and
a controller which controls the synchronizing signal output unit to output the synchronizing signal based on the operation mode of the three-dimensional glasses.

2. The display device according to claim 1, wherein the controller controls the display device to display information about at least one operation mode of the three-dimensional glasses for selection by a user of the operation mode of the three-dimensional glasses.

3. The display device according to claim 2, wherein the information about the operation mode of the three-dimensional glasses comprises a model name of the three-dimensional glasses.

4. The display device according to claim 1, wherein the controller changes a frequency of the synchronizing signal based on the operation mode of the three-dimensional glasses.

5. The display device according to claim 1, wherein the controller changes a wavelength of the synchronizing signal based on the operation mode of the three-dimensional glasses.

6. The display device according to claim 1, wherein the synchronizing signal output unit comprises a plurality of emitters which output a plurality of different synchronizing signals, respectively.

7. The display device according to claim 1, wherein the synchronizing signal output unit comprises an emitter which selectively outputs a plurality of different synchronizing signals.

8. The display device according to claim 6, wherein the synchronizing signals are different in at least one of frequency and wavelength.

9. The display device according to claim 7, wherein the synchronizing signals are different in at least one of frequency and wavelength.

10. A method of driving a display device, the method comprising:
outputting a synchronizing signal based on the operation mode of a three-dimensional glasses, to open and close the left shutter and the right shutter of the three-dimensional glasses corresponding to a left image and a right image displayed on the display device, respectively.

11. The method according to claim 10, further comprising displaying information about at least one operation mode so that a selection of the operation mode of the three-dimensional glasses is made by a user.

12. The method according to claim 10, wherein the outputting the synchronizing signal comprises changing a frequency of the synchronizing signal based on the operation mode of the three-dimensional glasses.

13. The method according to claim 10, wherein the outputting the synchronized signal comprises changing a wavelength of the synchronizing signal based on the operation mode of the three-dimensional glasses.

14. The method according to claim 10, wherein the outputting the synchronized signal comprises outputting the synchronizing signal from a plurality of emitters which output a plurality of different synchronizing signals, respectively.

15. The method according to claim 10, wherein the outputting the synchronized signal comprises outputting the synchronizing signal from an emitter which selectively outputs a plurality of different synchronizing signals.

16. The method according to claim 14, wherein the synchronizing signals are different in at least one of frequency and wavelength.

17. The method according to claim 15, wherein the synchronizing signals are different in at least one of frequency and wavelength.

18. A display device comprising:
a synchronizing signal output unit which outputs a plurality of synchronizing signals to open and close a left shutter and a right shutter of a three-dimensional glasses, for viewing an image displayed on the display device, corresponding to a left image and a right image displayed on the display device, respectively; and
a controller which controls the synchronizing signal output unit to output a synchronizing signal based on an operation mode of the three-dimensional glasses,
wherein the plurality of synchronizing signals are different in at least one of frequency and wavelength.

19. A method of driving a display device, the method comprising:
outputting a synchronizing signal based on an operation mode of a three-dimensional glasses, for viewing an image displayed on the display device, among a plurality of synchronizing signals being different in at least one of frequency and wavelength, in order to open and close a left shutter and a right shutter of the three-dimensional glasses corresponding to a left image and a right image, respectively, which are displayed on the display device.

20. The display device according to claim 1, further comprising a user input unit which receives input of a user input regarding an operation mode of the three-dimensional glasses for viewing an image displayed on the display device,
wherein the control unit controls the synchronization signal output unit to output the synchronizing signal based on the operation mode of the three-dimensional glasses provided in the received user input.

21. The display device according to claim 20, further comprising:
a signal receiving unit which receives the image including the left image and the right image;
a signal processing unit which processes the image received by the signal receiving unit; and
a display unit which displays a three-dimensional image based on the image signal processed by the signal processing unit.

22. The method according to claim 10, further comprising receiving user input regarding an operation mode of the three-dimensional glasses for viewing an image displayed on the display device, wherein the output synchronizing signal is based on the operation mode of the three-dimensional glasses provided in the received user input.

23. A display device comprising:
a synchronizing signal output unit which converts received right and left images to a format acceptable by a 3D glasses and outputs the right and left images in the format acceptable by the 3D glasses.

24. The display device of claim 23, further comprising an input unit which receives user input regarding an operation mode of the 3D glasses, wherein the format comprises frequency of switching from the left to right image and vise versa.

25. The display device of claim 23, further comprising:
outputting on a display at least two types of models of the 3D glasses,
wherein the user input regarding operation of the 3D glasses comprises a selection of one of the at least two types of models of the 3D glasses.

26. The display device of claim 23, wherein the user input comprises user inputting a frequency or wavelength of an operating signal of the 3D glasses.

27. The display device of claim 23, wherein the synchronizing signal output unit converts the received right and left images to a plurality of formats acceptable by different types of the 3D glasses.
